(19) United States
(12) Patent Application Publication
(10) Pub. No.: US 2015/0066786 A1
(43) Pub. Date: Mar. 5, 2015

(54) METHOD AND SYSTEM OF PRESENTING A REAL ESTATE AGENT TO A LEAD IN A REAL ESTATE COMPUTING PLATFORM

(71) Applicant: Mahnaz Westerberg, Palo Alto, CA (US)

(72) Inventor: Mahnaz Westerberg, Palo Alto, CA (US)

(21) Appl. No.: 14/289,543

(22) Filed: May 28, 2014

Related U.S. Application Data
(60) Provisional application No. 61/829,007, filed on May 30, 2013.
(60) Provisional application No. 61/936,866, filed on Feb. 6, 2014.

(51) Int. Cl. G06Q 50/16; G06F 17/30

(52) U.S. Cl. CPC G06Q 50/16; G06F 17/30905
USPC 705/313

(57) ABSTRACT

In one exemplary embodiment, with at least one processor, a computerized real estate platform. With the computerized real estate platform, at least one web page document is provided. The web page document includes real estate content. A request from a user computing device for the web page document is received. The request includes a referring real estate agent identifier. A referring real estate agent is identified based on the referring real estate agent identifier. The user computing device is associated with the referring real estate agent. The web page document is modified into include an information about the referring real estate agent and instructions to display the information in a display of the web page document in a web browser of the user computing device. A time period countdown is initiated. The time countdown period indicates a remaining time before the web page document is no longer modified to include the information about the referring real estate agent.

### CROSS-REFERENCE TO RELATED APPLICATIONS

This application is a claims priority, to U.S. provisional patent application No. 61/829,007, titled Virtual Escrow Application and filed on May, 30, 2013 and U.S. provisional patent application No. 61/936,866, titled Virtual Escrow Application 2 and filed on Feb. 6, 2014. These provisional applications are hereby incorporated by reference in their entirety.

### BACKGROUND

1. Field

This application relates generally to the real-estate field, and more particularly to a system, method and article of manufacture of presenting a real estate agent to a lead in a real estate computing platform.

2. Related Art

There are a number of methods of lead generation for real estate transactions. In one example, a real estate agent can advertise ma physical periodical. However, the real estate agent may not be able to determine the number, if any, of leads created from the advertisement. The real estate agent may also post listings and/or advertise on art online real estate website. However, many online real estate websites are designed simply to attract visitors and generate advertisement revenue. The real estate agent may be one of many other agents (as well as one of many products, some of which may have little or nothing to do with real estate) advertised on the online real estate website. Accordingly, the leads generated may not demonstrate the actual interests/attributes of the lead or the lead may have low interest in a real estate transaction. In other words, these leads may be low value leads. Therefore, improvements to the methods and systems of generating and managing leads for real estate agents can lead to, not only developing stronger leads, but to higher rates of engagement of leads with a real estate computing platform.

### BRIEF SUMMARY OF THE INVENTION

A method includes the step of providing, with at least one processor, a computerized real estate platform. With the computerized real estate platform, at least one web page document is provided. The web page document includes real estate content. A request from a user computing device for the web page document is received. The request includes a referring real estate agent identifier. A referring real estate agent is identified based on the referring real estate agent identifier. The user computing device is associated with the referring real estate agent. The web page document includes information about the referring real estate agent and instructions to display the information in a display of the web page document in a web browser of the user computing device. A time period countdown is initiated. The time countdown period indicates a remaining time before the web page document is no longer modified to include the information about the referring real estate agent.

Optionally, the user computing device can be a mobile device. The referring real estate agent identifier can include a code in a portion of the uniform resource locator reference in a hyperlink. The hyperlink can be included in a marketing email from the real estate agent to the user. The code can include a string of characters unique to the real estate agent. The time countdown period such as a thirty-day countdown or any other time countdown period. Each request by the user computing device during the time countdown period can causes any web page document to be modified to include the information about the referring real estate agent. The web page document can be configured to include, an option that enables a user of the user computer device to communicate an instruction to cease modification of the web page document to include the information about the referring real estate agent.

### BRIEF DESCRIPTION OF THE DRAWINGS

The present application can be best understood by reference to the following description taken in conjunction with the accompanying figures, in which like parts may be referred to by like numerals.

FIG. 1 depicts an example process of presenting a real estate agent to a lead in a real estate computing platform, according to some embodiments.

FIG. 2 illustrates an example of simultaneously providing information about the real estate agent with a real estate web page, according to some embodiments.

FIG. 3 illustrates an example process of presenting a real estate agent to a real estate lead in a web page, according to some embodiments.

FIG. 4 illustrates another example process of presenting a real estate agent to a real estate lead in a web page, according to some embodiments.

FIG. 5 is a block diagram of an example of a real-estate computing platform, according to some embodiments.

FIG. 6 is a block diagram of a sample computing environment that can be utilized to implement some embodiments.

FIG. 7 depicts an exemplary computing system that can be configured to perform any one of the processes provided herein.

The Figures described above are a representative see, and are not an exhaustive with respect to embodying the invention.

### DESCRIPTION

Disclosed are a system, method, and article of manufacture of presenting a real estate agent to a lead in a real estate computing platform. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following, description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the Cot responding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Real estate property can consist of land or buildings (e.g. homes, commercial buildings, etc).

Real estate agent can be a person who acts as an intermediary between sellers and buyers of real estate/real property.

Real estate lead can be a person who is interested in entering into a real-estate transaction other than the real estate agent (e.g. selling a home, purchasing a home, renting an office, and the like). For example, a real estate lead can be a potential real estate customer.

Real estate platform can be a computing system with applications for implementing various real estate dealings and transactions (e.g. viewing, real estate images and videos, providing information about real estate, providing real estate agents information, etc.). Real estate platform can be implemented in a client/server and/or cloud-computing paradigm according to various example embodiments.

### Process Overview

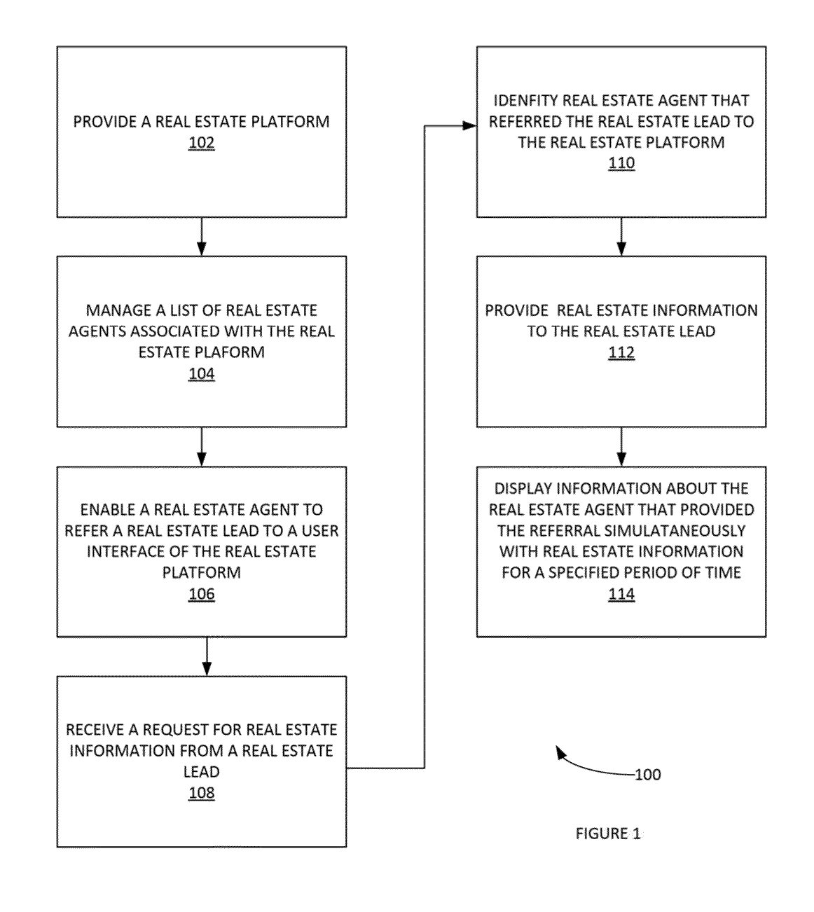

FIG. 1 depicts an example process 100 of presenting a real estate agent to a lead in a real estate computing platform, according to some embodiments. In step 102 of process 100, a real estate platform can be provided. The real estate platform can include a web site that provides real-estate information. The real estate platform can include online real estate database. The real estate platform can include a search engine for search said online real estate database. The real estate platform can include information/functionalities, such as, inter alia: online web blogs (e.g. written by real estate agents), an online web magazine, virtual tours of real estate offerings, tools for generating virtual tours of real estate offerings, etc. In some examples, the real estate platform can include a suite of services that enables real estate brokers to establish contractual offers of compensation (e.g. among brokers), facilitates cooperation with other broker participants, accumulates and disseminates information to enable appraisals, and is a facility for the orderly correlation and dissemination of listing information to better serve broker's clients, customers and the public. In some examples, the real estate platform can also be accessed via a client-side mobile application.

In step 104, a list of real estate agents can be associated with the real estate platform. For example, the real estate agents can subscribe to the real estate platform in exchange for fees and/or services. The list of real estate agents can be automatically managed by servers in the real estate platform. In step 106, a real estate agents associated with the real estate platform can be enabled to refer a real estate lead to a user-interface view (e.g. a web page, a mobile device application view, etc.) of the real estate platform. For example, the real estate agent can provide a hyperlink to the real estate lead in an email. The real estate lead can access a web site managed by the real estate platform via the hyperlink. Accordingly, in step 108, the real estate platform can receive a request for real estate information (e.g. view/search for real estate listings, search for real estate agents, read a web magazine, etc.).

In step 110, each time a request for real estate information is made, the real estate agent that referred, the real estate lead can be identified. For example, the hyperlink can include identifying information of the real estate agent. In one example, the uniform resource locator (URL) string of characters (or other uniform resource identifier (URI) method) can be configured to identify the real estate agent to the real estate platform. Real estate agents associated with the real estate platform can register an identifier URL with the real estate platform. Identifiers can be automatically assigned by the system to real estate agents.

In step 112, the real estate platform can provide the real estate information to the real estate lead. For example, the real estate information can be served in a web page document and/or via a mobile device application. In step 114, the real estate platform can simultaneously provide (e.g. as a digital image and/or text in the same web page document as the real estate information) information about the real estate agent. Step 114 can be performed for a specified time period (e.g. thirty (30) days, six months, one week, another specified time period, etc.).

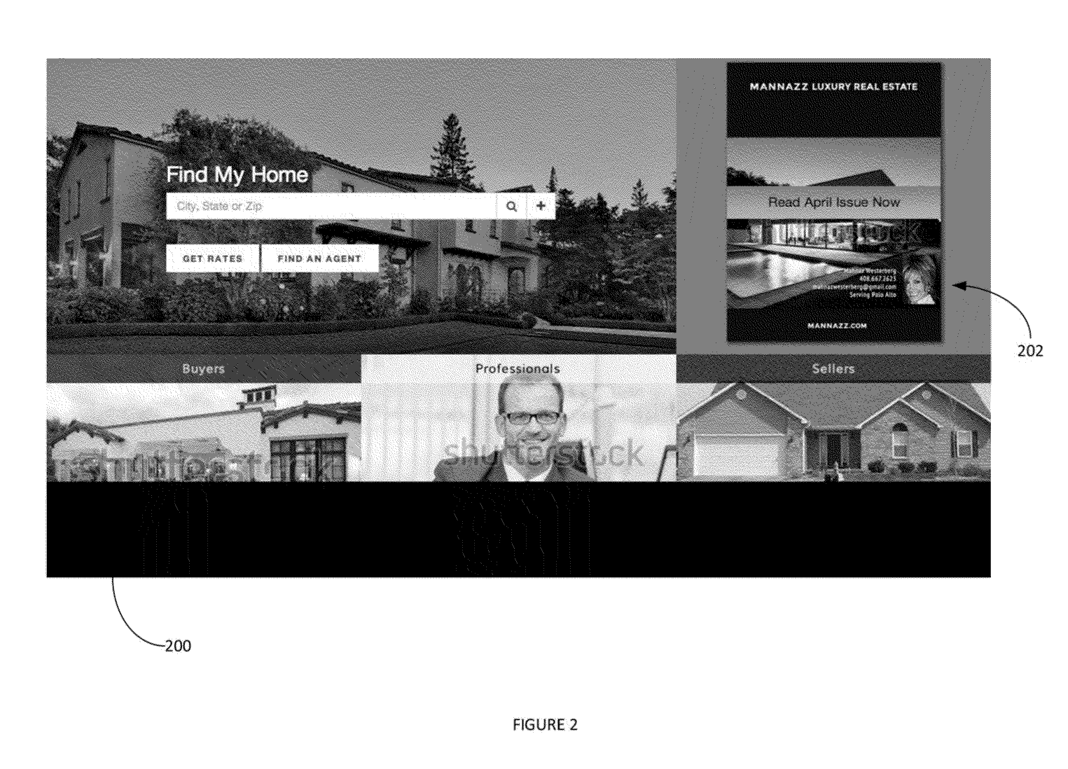

FIG. 2 illustrates an example of simultaneously providing information 202 about the real estate agent with a real estate web page 200, according to some embodiments. A real estate agent may have provided a real estate lead a hyperlink to the web page 200. The real estate lead may have used the hyperlink to access the web page 200. The hyperlink (and/or other metadata such as URL codes referenced in the hyperlink, HTTP cookies in the real estate lead's web browser, etc.) can be used to identify the real estate agent. The web server (e.g. a web server of the real estate platform discuss with respect to process 100) of the real estate web page 200 can then identify the real estate agent. The web server can include a database of real estate agent information. The database can include digital image(s) of the real estate agent. The database can include current contact information about the real estate agent. The database can include specializations and/or accomplishments of the real estate agent. The database can include digital video(s) of the real estate agent discussing various aspects of a real estate topic (e.g. discussing another aspect of real estate web page 200 and/or an item of real estate displayed on real estate web page 200). The web server can modify the code of the web page document of real estate web page 200 to include sonic or all of this information. For example, the web server can modify the markup language of the web page document. For example, the webs server can insert, the digital image of the real estate agent as new Hyper Text Markup Language (HTML) code into the HTML code of real estate web page 200. In another example, Asynchronous JavaScript and XML (AJAX) techniques can be used to modify the portion of the web page document with the real estate agent information. Web server can update the Cascading Style Sheets (CSS) and/or JavaScript script code of the real estate web page 200 as well. Accordingly, the present view of the real estate web page 200, an image of the referring real estate agent and her contact information is displayed. If another real estate agent had provided the referral then that real estate agent's image and/or contact information would have been available instead. Real estate web page 200 is provided by way of example and not of limitation.

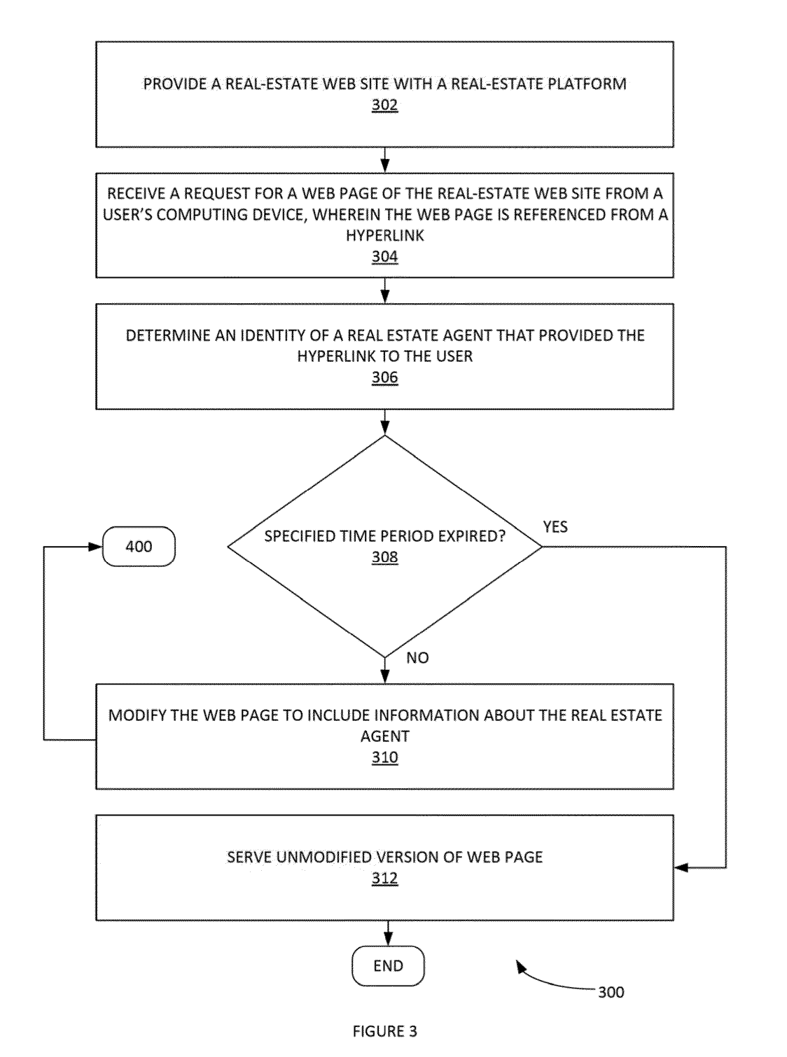

FIG. 3 illustrates an example process 300 of presenting a real estate agent to a real estate lead in a web page, according, to some embodiments. In step 302, a real estate computing, platform provides a real estate website (e.g. MANNAZZ.COM). In step 304, the real estate computing, platform can receive a request for a webpage of the real estate website from a user computing device (e.g. a personal computer, a laptop computer, a wearable computer (e.g. Google Glass®), a tablet computer, a smart phone, and the like). The webpage can be referenced from a hyperlink. In step 306, an identity of a real estate agent that provided the hyperlink to the user can be determined. For example, the hyperlink may be communicated to the user computing device from a real estate agent computing device via such electronic messaging protocols as, inter anal short messaging service (SMS) message, multimedia messaging service (MMS), e-mail, microblog post, online social networking post, augmented-reality message, web page content, and the like. Various information can be embedded in the hyperlink to identify the real estate agent (e.g. information that identifies the real-estate agent's sending computing device, metadata in the hyperlink, the URL of the webpage referenced by the hyperlink, etc.)

In step 308, it can be determined if a specified time period has expired. For example, the first time the user access the website, a time clock for thirty days can begin. For the next thirty days, each time the user access the web site, images (and/or other information) of the referring real estate agent can be made available to the user. If no, then process 300 can proceed to step 310. In step 310, the web page (e.g. all web pages, specified web pages, etc.) served to the user computing device can be modified to include the referring real estate agent's information. Process 300 can then proceed to process 400 in some example embodiments. If yes, then process 300 can proceed to step 312. In step 312, an unmodified version of the web page can be served. It is noted that users can opt out of being served referring real estate agent information in some examples. In some embodiments, process 300 can be implemented when a referred user first utilizes the hyperlink to access the real estate platform's website. Process 400 (see infra) can then be implemented when the user returns to the real estate platform's website.

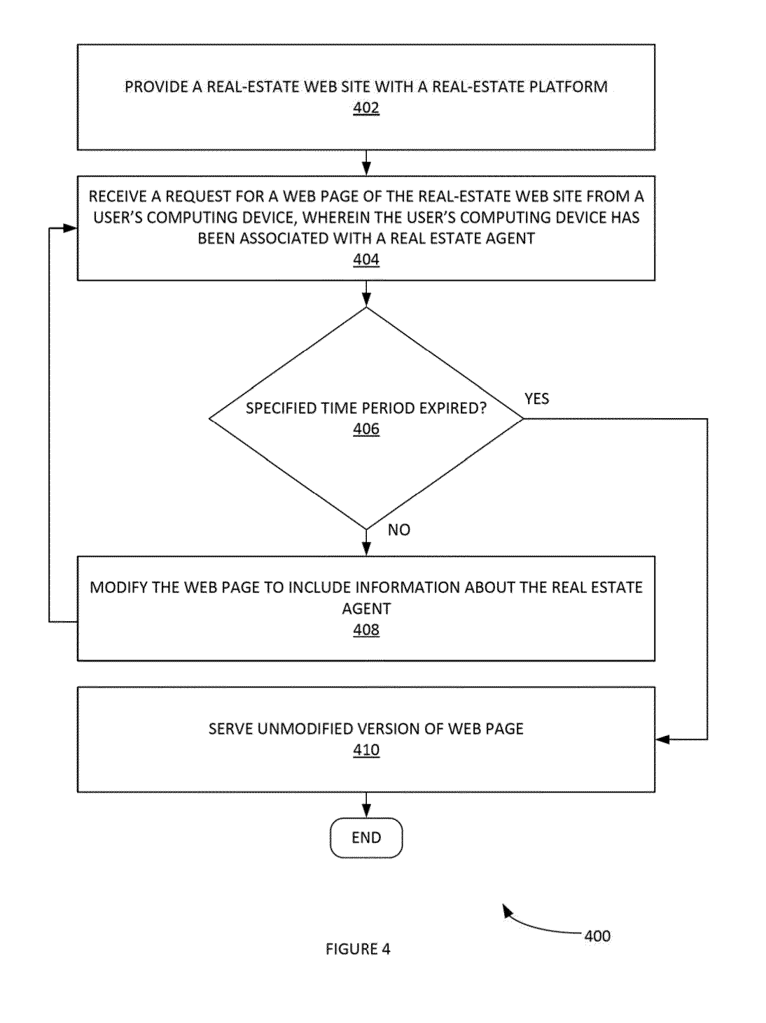

FIG. 4 illustrates another example process 400 of presenting a real estate agent to a real estate lead in a web page, according to some embodiments. As noted in the figures and supra, process 400 can be an extension of process 300. In step 402, a real estate computing platform provides a real estate website (e.g. MANNAZZ.COM). In step 404, the real estate computing platform can receive a request for a webpage of the real estate website from a user computing device. The user's computing device can have been associated with the real estate agent (e.g. using HTTP cookies, matching a media access control address (MAC address) of the computing device with the referring real estate agent, matching an Internet Protocol (IP) address of the computing device with the referring real estate agent, matching another unique identifier of the computing device with the referring real estate agent, etc.). In step 406, it can be determined if a specified time period has expired. For example, the first time the user access the website, a time clock for thirty days can begin. For the next thirty days, each time the user access the web site, images (and/or other information) of the referring real estate agent can be made available to the user. If no, then process 400 can proceed to step 408. In step 408, the web page (e.g. all web pages, specified web pages, etc.) served to the user computing device can be modified to include the referring real estate agent's information. Process 400 can then return to process 404 in some example embodiments. If yes, then process 400 can proceed to step 410. In step 410, an unmodified version of the web page can be served. Process 400 can then end as noted in the figure. For example, in the even the user returns to the real estate website, the user's computing device can be served unmodified versions of the web page documents.

### Exemplary Environment and Architecture

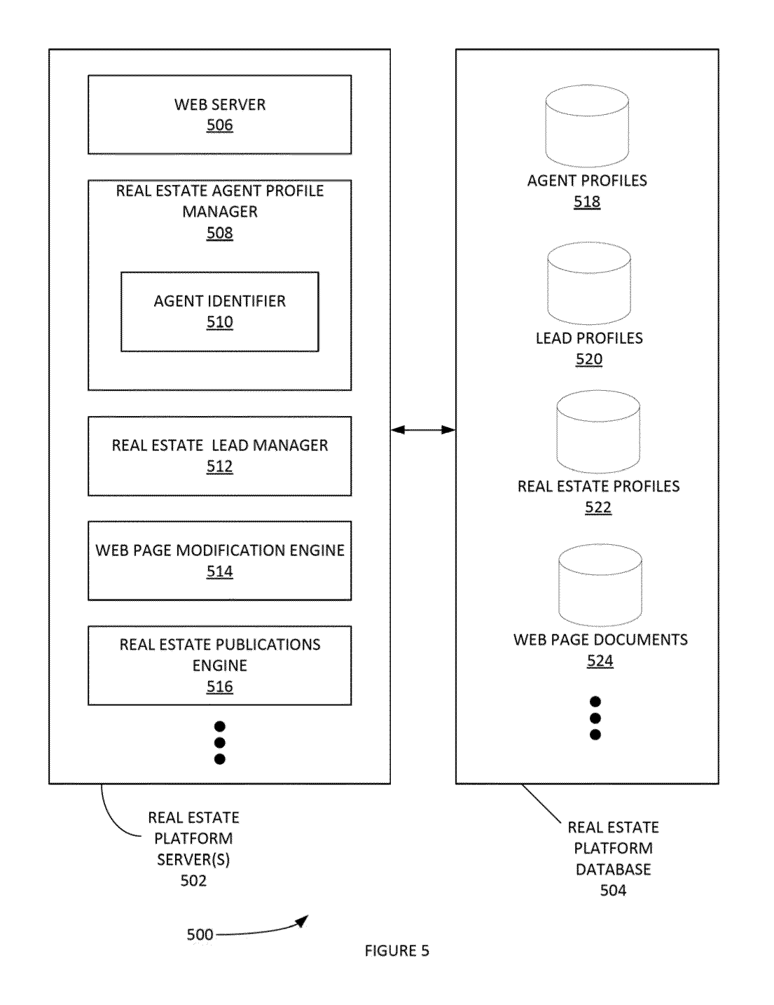

FIG. 5 is a block diagram of an example of a real-estate computing platform 500, according to some embodiments. Real-estate computing platform 500 can implement processes 100, 200, 300 and/or 400. Real-estate computing platform 500 can include real-estate computing platform server(s) 502 and real-estate computing platform database(s) 504. Real-estate computing platform server(s) 502 can include various applications and functionalities provided herein. Real-estate computing platform server(s) 502 can include a web server 506. Web server 506 can include hardware and software that deliver web content that can be accessed through the Internet. Real-estate computing platform server(s) 502 can include real estate agent profile manager 508. Real estate agent profile manager 508 can include hardware and software that manage real estate agent profiles. Real estate agents can upload and otherwise generate profiles. These profiles can include biographical information, professional certification information, digital images, digital videos and the like. Real estate agent profile manager 508 can further include an agent identifier 510. Agent identifier 510 can identify referring real estate agents associated with real estate leads (e.g. utilizing the methods provided supra such as mapping URL codes, hyperlink metadata, MAC addresses, HTTP cookies, etc. with specified referring real estate agents). Real estate agent profile information can be stored in agent profiles database 518. Agent profiles database 518 can include real estate lead information such as, inter alia: lead names, lead cookie and other tracking data, associated real estate agent(s), lead profiles, lead interests (e.g. as obtained from the lead's web browsing history in the real estate platform's website), and the like.

Web page modification engine 514 can modify web page documents requested users to include information about the real estate agent that referred the user to the web site of real estate platform 500. Web page modification engine 514 can implement processes 100, 300 and 400 for example. Web page modification engine 514 can generate the web page 200.

Real-estate computing platform server(s) 502 can include various other modules and tools that implement various other functionalities of the real estate platform 500. For example, real-estate computing platform server(s) 502 can include real estate publications engine 516. Real estate publications engine 516 can automatically generate real-estate related web blogs and/or online magazines based on content provided by real estate agents. This content can be parsed by such factors as, inter alia: location, real estate agent specialization and experience, price ranges of real estate, market analysis, and the like. Real estate profiles 522 can include information about real estate associated with the real estate platform (e.g. digital images, virtual tours, transaction histories, covenants, pricing information, etc.). Web page documents 524 can include the web page documents and other information (e.g. videos, images, and the like) used in the web site. In some embodiments, system 500 can be configured to provide preferred advertising for agents that provide the applications to prospects/leads. Preferred advertising can include priority over other advertisers with respect to locations on a web page, order of display to a web site visitor, size of advertisement with respect to other advertisements, etc.

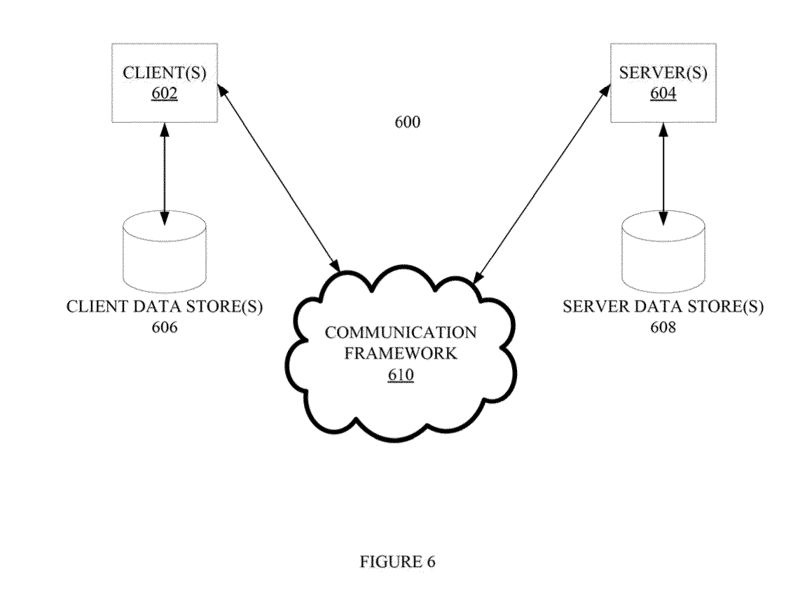

FIG. 6 is a block diagram of a sample computing environment 600 that can be utilized to implement some embodiments. The system 600 further illustrates a system that includes one or more client(s) 602. The client(s) 602 can be hardware and/or software (e.g., threads, processes, computing devices). The system 600 also includes one or more server(s) 604. The server(s) 604 can also be hardware and/or software (e.g., threads, processes, computing devices). One possible communication between a client 602 and a server 604 may be in the form of a data packet adapted to be transmitted between two or more computer processes. The system 600 includes a communication framework 610 that can be employed to facilitate communications between the client(s) 602 and the server(s) 604. The client(s) 602 are connected to one or more client data store(s) 606 that can be employed to store information local to the client(s) 602. Similarly, the server(s) 604 are connected to one or more server data store(s) 608 that can be employed to store information local to the server(s) 604.

FIG. 6 is provided by way of example, in other embodiments, the methods and systems provided herein can be implemented in cloud-computing environments such as the Amazom.com's® cloud-computing services For example, system 500 can be implemented as a virtual machine(s) in a cloud-computing environment.

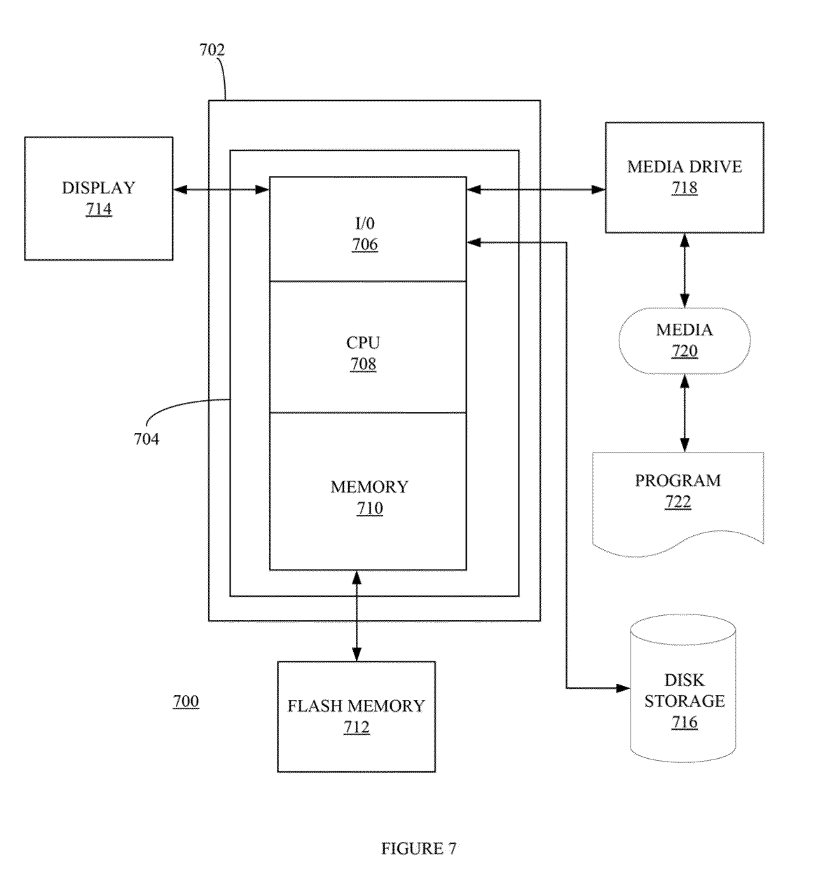

FIG. 7 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. In another example, computing system 700 can be configured as a mobile device and include such systems as may be typically included in a mobile device such as GPS systems, gyroscope, accelerometers, cameras, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method comprising:
providing, with at least one processor, a computerized real estate platform;
providing, with the computerized real estate platform, at least one web page document, wherein the web page document comprises real estate content;
receiving a request from a user computing device for the web page document, wherein the request includes a referring real estate agent identifier;
identifying a referring real estate agent based on the referring real estate agent identifier;
associating the user computing device with the referring real estate agent;
modifying the web page document into include an information about the referring real estate agent and instructions to display the information in a display of the web page document in a web browser of the user computing device; and
initiating a time period countdown, wherein the time countdown period indicates a remaining time before the web page document is no longer modified to include the information about the referring real estate agent.

2. The method of claim 1, wherein the user computing device comprises a mobile device.

3. The method of claim 1, wherein the referring real estate agent identifier comprises a code in a portion of the uniform resource locator reference in a hyperlink.

4. The method of claim 3, wherein, the hyperlink is included in a marketing email from the real estate agent to the user.

5. The method of claim 4, wherein the code comprises a string of characters unique to the real estate agent.

6. The method of claim 5, wherein the time countdown period comprises a thirty-day countdown.

7. The method of claim 6, wherein each request by the user computing device during the time countdown period causes any web page document to be modified to include the information about the referring real estate agent.

8. The method of claim 7, wherein the web page document is configured to include an option that enables a user of the user computer device to communicate an instruction to cease modification of the web page document to include the information about the referring real estate agent.

9. A server system for implementing a real-estate computing platform comprising:
a processor configured to execute instructions;
a memory containing instructions when executed on the processor, causes the processor to perform operations that:
provide, with at least one processor, a computerized real estate platform;
provide, with the computerized real estate platform, at least one web page document, wherein the web page document comprises real estate content;
receive a request from a user computing device for the web page document, wherein the request includes a referring real estate agent identifier;
identify a referring real estate agent based on the referring real estate agent identifier;
associate the user computing device with the referring real estate agent;
modify the web page document into include an information about the referring real estate agent and instructions to display the information in a display of the web page document in a web browser of the user computing device; and
initiate a time period countdown, wherein the time countdown period indicates a remaining time before the web page document is no longer modified to include the information about the referring real estate agent.

10. The server system of claim 9, wherein the user computing device comprises a mobile device.

11. The server system of claim 10, wherein the referring, real estate agent identifier comprises a code in a portion of the uniform resource locator reference in as hyperlink.

12. The server system of claim 11, wherein the hyperlink is included in a marketing email from the real estate agent to the user.

13. The server system of claim 12, wherein the code comprises a string of characters unique to the real estate agent.

14. The server system of claim 13, wherein the time countdown period comprises a thirty-day countdown.

15. The server system of claim 14, wherein each request by the user computing device during the time countdown period causes any web page document to be modified to include the information about the referring real estate agent.

16. The server system of claim 15, wherein the web page document is configured to include an option that enables a user of the user computer device to communicate an instruction to cease modification of the web page document to include the information about the referring real estate agent.
